(19) United States
(12) Patent Application Publication
(10) Pub. No.: US 2023/0224215 A1
(43) Pub. Date: Jul. 13, 2023

(54) METHODS AND SYSTEMS FOR DHCP POLICY MANAGEMENT

(71) Applicant: BLUECAT NETWORKS, INC., Toronto (CA)

(72) Inventors: Steven P. Meyer, Richmond Hill (CA); Timothy Krzywonos, Bowmanville (CA); Osama Elsharif, Toronto (CA)

(21) Appl. No.: 18/093,296

(22) Filed: Jan. 4, 2023

Related U.S. Application Data
(63) Continuation of application No. 17/469,503, filed on Sep. 8, 2021, now abandoned.
Application No. 17/469,503 is a continuation of application No. 17/035,677, filed on Sep. 28, 2020, now abandoned.
Application No. 17/035,677 is a continuation of application No. 16/659,487, filed on Oct. 21, 2019, now abandoned.
Application No. 16/659,487 is a continuation of application No. 15/094,807, filed on Apr. 8, 2016, now abandoned.
(60) Provisional application No. 62/145,996, filed on Apr. 10, 2015.

(51) Int. Cl. H04L 41/0816; H04L 67/00; H04L 67/303; H04L 61/5014; H04L 41/0604; H04L 41/0893; H04L 41/22

(52) U.S. Cl. CPC H04L 41/0816; H04L 67/34; H04L 67/303; H04L 61/5014; H04L 41/0604; H04L 41/0893; H04L 41/22

(57) ABSTRACT

Methods and systems are disclosed for configuring a network consisting of an IP Policy Management (IPPM) service and a plurality of distributed network devices supporting DHCP and other service roles wherein network devices are discovered by the IPPM service and the configuration for each of the network devices is determined by the selection of a policy, wherein the policy is made up of a plurality of rules specific to the service roles and capabilities of the network devices, and the configuration of each of the network devices is deployed via the network to the network devices.

### CROSS-REFERENCE TO RELATED APPLICATIONS

The present application is a continuation of U.S. patent application Ser, No. 17/469,503, filed Sep. 8, 2021, which is a continuation of U.S. patent application Ser. No. 17/035,677, filed Sep. 28, 2020, now abandoned, which is a continuation of U.S. patent application Ser. No. 16/659,487, filed Oct. 21, 2019, now abandoned, which is a continuation of U.S. patent application Ser. No. 15/094,807, filed Apr. 8, 2016, now abandoned, which claims priority pursuant to 35 U.S.C. § 119(e) to U.S. Provisional Patent Application No. 62/145,996, filed Apr. 10, 2015, all of which are incorporated herein by reference in their entireties and for all purposes.

### FIELD OF THE INVENTION

The field of the invention relates to the field of DHCP Policy Management in a network.

### BACKGROUND OF THE INVENTION

Dynamic Host Configuration Protocol (DHCP) was developed in the 1980's to allow “workstations to dynamically find their protocol address” as described in A Reverse Address Resolution Protocol, Finlayson et. al., Jun 1984, IETF and for “passing configuration information to hosts” as described in [RFC1531(https://tools.ietf.org/html/r fc1531)/and RFC1541 (https://tools.ietf.org/html/rfc1541)], and it has become one of the cornerstones of computer networking. Other background information can be found in U.S. Pat. No. 8,543,674 and European Patent No. 2048857, which are hereby incorporated by reference in their entirety.

The expansion of the number and types of network devices has made DHCP one of the most widely used network protocols. Modern practices in network monitoring, security, coordination and control often depend on policies that determine how network addresses are assigned and which DHCP options must accompany the assignment of addresses.

IP Address Management (IPAM) has been developed to manage all aspects of DHCP and DNS services for large networks, and these networks often include 2 or more specialized servers running DHCP that support large numbers of host computer clients. Such servers can be expensive to install and maintain and complicated to manage and therefore may be best suited for use by large corporations and service providers. Small installations often rely on the DHCP servers that come with their routers, wireless access points, network switches and devices that may host networks, including virtual machine stations, laptops, tablets, smartphones and others. These installations are constrained by the use of the limited tools provided with the routers and other devices. IPAM is typically only one aspect of network policy that also includes other services, such as security and routing services.

A notable trend in modern IP networks is the proliferation of subnets, as is the case in small businesses and organizations, educational institutions, residences and other entities. There is a corresponding increasing presence of numerous DHCP servers to provision host devices with IP addresses and network configuration information. Many network infrastructure devices, such as routers, network switches, wireless access points, gateways and others have built-in DHCP servers that are not always used. Virtual machine hosts and cloud platforms supporting virtual networks often also have built-in DHCP servers, for example VMWare's VMXNET (See: vmxnet3—vmware kernel module, OpenVM Tools, VMWare, 2011). Configuring a large number of network infrastructure devices requires a significant level of network expertise and is time-consuming using current tools because each subnet must be individually considered. In addition, it can be difficult to monitor the correct behavior of network infrastructure devices because there is no uniform way to configure and collect lease and device identity information from large numbers of diverse devices. Examples of device identity information include MAC addresses and unique device identifiers (DUID).

Each DHCP server requires a specific configuration in order to integrate with a larger network in conformance with a network policy. Unfortunately, however, although most DHCP servers are derived from a very small set of technical implementations, such as the implementations from Internet Systems Consortium (See: DHCP server documentation, Internet Systems Consortium, 2001-2015), there is no standard way to discover the presence and type of DHCP servers, to monitor the behavior of said servers or to coordinate the configuration of said servers. Discovering, monitoring and coordinating the configuration often requires significant hands-on interaction for network administrators and presents a particular challenge where many different server types are used.

Furthermore, DHCP service configurations do not exist in isolation, and such service configurations must be coordinated with other service configurations, such as DNS services, managed switches, gateways, firewalls, proxy servers, VPN tunnels, wireless access points, and others. In addition, achieving a desired level of network performance and security can also require configuration of a number of services other than DHCP, such as (but not limited to) routing, quality of service (QoS) and firewall-protection. Increasingly, some of these services can exist remotely from the DHCP devices, for example, cloud-based DNS services.

Methods and systems are therefore required that can monitor behavior of DHCP and associated network infrastructure services and automatically deploy and coordinate network policies over a wide area distributed network containing many services of various types.

Thus, needs exist for improved techniques for network policy updating, coordination, application and deployment regardless of the type of DHCP and other service configurations implemented.

### SUMMARY

Provided herein are embodiments of for network device discovery and network policy updating, coordination, application and deployment regardless of the type of DHCP and other service configurations implemented. The configuration of these devices is described in detail by way of various embodiments which are only examples.

Methods are disclosed for configuring a network consisting of an IP Policy Management (IPPM) service and a plurality of distributed managed network devices supporting DHCP and other service roles. Managed network devices are discovered by the IPPM service and the configuration of each of the managed network devices is determined by the selection of a policy including a plurality of rules specific to the service roles and capabilities of the network devices. Configuration of each of the network devices is deployed via the network to the network devices.

Systems are disclosed for configuring a network consisting of an IPPM service and a plurality of distributed network devices supporting DHCP and other service roles. Network devices are discovered by the IPPM service and the configuration of each of the network devices is determined by the selection of a policy including a plurality of rules specific to the service roles and capabilities of the network devices. Configuration of each of the network devices is deployed via the network to the network devices.

Other systems, devices, methods, features and advantages of the subject matter described herein will be or will become apparent to one with skill in the art upon examination of the following figures and detailed description. It is intended that all such additional devices, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

Illustrated in the accompanying drawing(s) is at least one of the best mode embodiments of the present invention. In such drawing(s):

FIG. 1 is an example embodiment of a generalized network architecture.

FIG. 2 is an example embodiment of a network device configuration flowchart.

FIG. 3 is an example embodiment of network device components.

FIG. 4 is an example embodiment of a per-device policy diagram.

FIG. 5 is an example embodiment of a rule application chart.

FIG. 6 is an example embodiment of a user input policy definition page.

FIG. 7 is an example embodiment of an automatic network representation diagram.

FIG. 8 is an example embodiment of a device configuration editor user interface screen.

FIG. 9 shows example embodiments of smart appliances.

### DETAILED DESCRIPTION

Before the present subject matter is described in detail, it is to be understood that this disclosure is not limited to the particular embodiments described, as such may vary. It is also to be understood that the terminology used herein is for the purpose of describing particular embodiments only, and is not intended to be limiting, since the scope of the present disclosure will be limited only by the appended claims.

Provided herein are embodiments for discovering and capturing network devices to be managed; defining and updating a network policy for the managed network devices; applying said network policies to generate service configurations for the managed network devices; and automatically deploying the service configurations to the managed network devices.

### Discovery and Capture

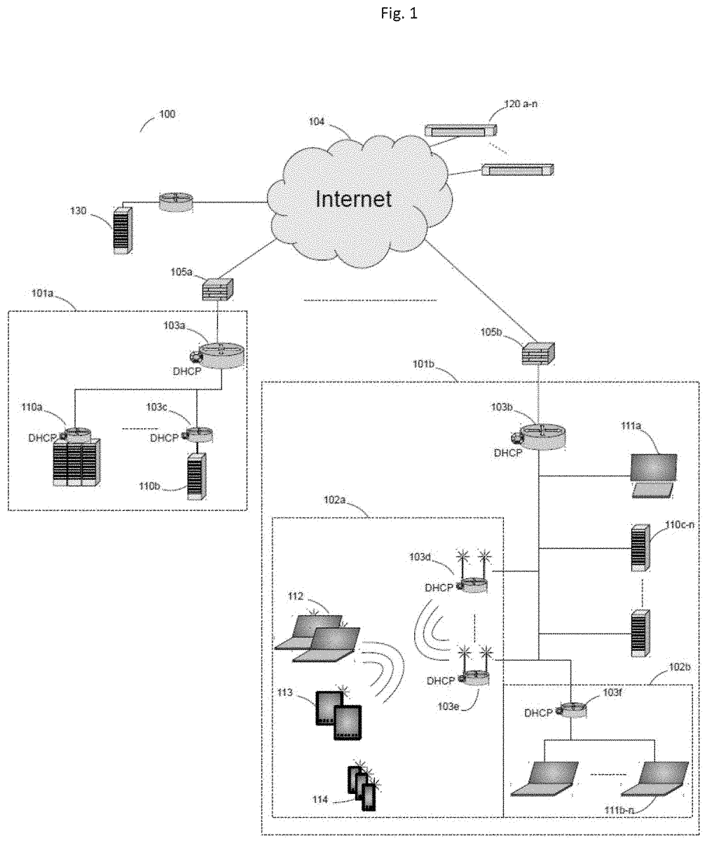

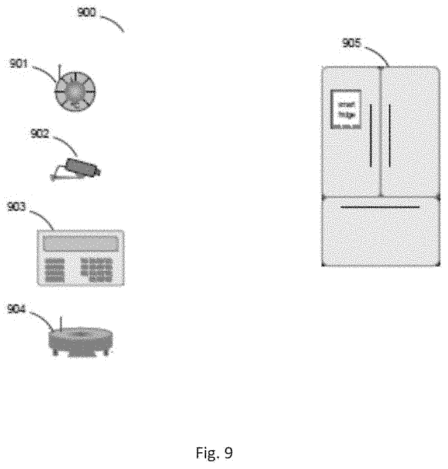

As illustrated by FIG. 1, an example embodiment of a generalized network system architecture 100 can comprise one or more networks 101a, 101b which can each include zero or more subnetworks. Here, network 101b includes subnetworks 102a, 102b. Each network 101a, 101b is communicatively coupled in a hierarchy by managed network devices 103a and 103b respectively that can include service roles for switches, routers, gateways, firewalls, wireless, DHCP, proxies, VPN, DNS and others. For example, 103a and 103b may be routers with DHCP service capabilities. Network 101a, network 101b and its associated subnetworks 102a and 102b can be communicatively coupled or otherwise connected to the Internet 104 by managed network devices 105a and 105b, respectively, such as firewalls, modems or others. Coupled to networks 101a, 101b and subnetworks 102a, 102b can be one or a plurality of host devices. For network 101a this includes servers 110a and 110b. For wireless subnetwork 102a this includes personal computers 112 such as laptops, tablets 113, smartphones 114 and other wireless devices. For wired subnetwork 102b this includes wired workstations 111b-n. For Network 101b this also includes servers 110c-n and wired workstation 111a. In various embodiments additional host devices can include smart appliances; virtual machines; wired or wireless devices such as personal wearable devices, environment monitors and controllers, physical security devices and others (see also FIG. 9, 900 generally).

The network system architecture 100 can also include an IP Policy Manager (IPPM) service 130 stored in non-transitory memory and hosted on an Internet cloud-based service or Internet-based server and Internet-based cloud services 120a-n for use by the host devices and communicatively coupled to the network 104. Examples of cloud services 120a-n include Domain Name Services (DNS), Network Time Protocol (NTP) services, logging services and others.

It should be understood that devices and networks used to implement the generalized architecture described above are known in the art and generally include processors, instructions stored in non-transitory memory and executable by the processors, non-transitory storage media for storing data in databases, power modules, communication signal transmitters/receivers, protocols, and others as appropriate.

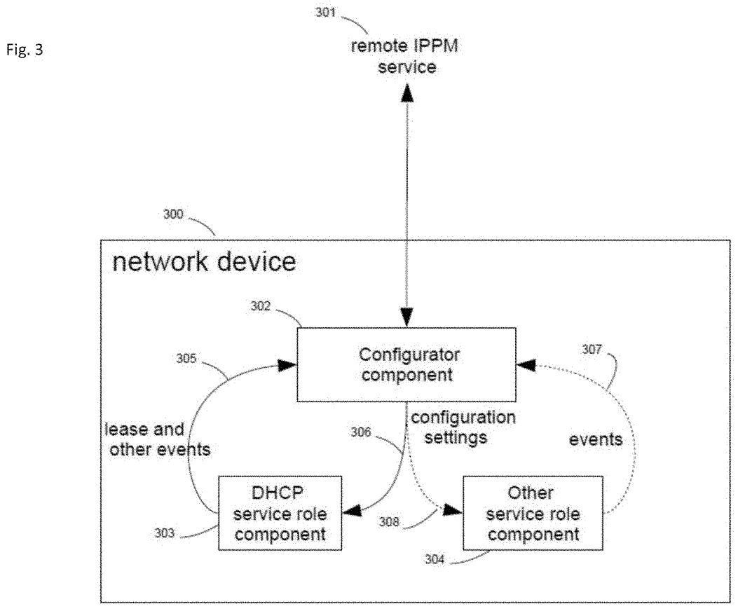

As shown in the example embodiment diagram of FIG. 3, a network device 300 (such as network device 103b of FIG. 1) can include a DHCP service role component 303, operable to provide network addresses to devices hosted on a communicatively coupled local subnetwork. Each DHCP service can be locally connected to a co-located configurator component 302 whereby the configurator component 302 can be in communication with a remote IP Policy Manager (IPPM) service 301, such that DHCP network event and status information 305 such as lease information can be forwarded up to the remote IPPM service 301 and subnetwork configuration information 306, in accordance with network policies defined for the particular subnetwork by the IPPM service 301, can be forwarded down to the DHCP service 303 via the configurator component 302. Examples of these can be seen in U.S. Pat. No. 8,543,674, which is incorporated by reference in its entirety.

Similarly, managed network device 300 can include additional or other service role components 304 locally connected and communicatively coupled to the configurator component 302, whereby network event and status information 307 can be forwarded up to the remote IPPM service 301 and service role configuration information 308, in accordance with network policies defined for the particular subnetwork by the IPPM service 301, can be sent down to the configurator component 302 and then to the service role component 304.

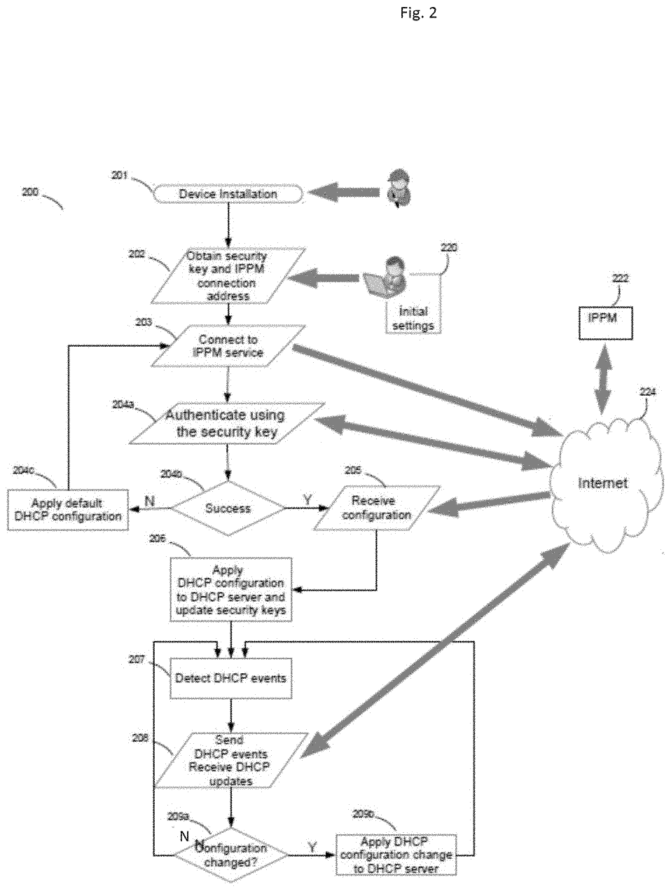

In an example embodiment, a managed network device (see also 300 of FIGS. 3 and 103b of FIG. 1) such as a wireless router can be physically installed to provide network services such as 802.11 (Wi-Fi) and configured according to a method or process as shown in the example embodiment flowchart 200 of FIG. 2. After physical device installation 201, initial configuration of the managed device, such as creating or updating initial settings sufficient to allow the device to connect to the network IPPM service, can be performed by a vendor or the owner in step 220 after the device is first turned on. In a typical scenario the vendor or owner in step 220 can access the internal setup page of the device from a locally-connected host, such as a computer or laptop, using a web browser and enter the following information as shown in step 202: a.) A security key phrase or password unique to the owner and b.) A URL or IP address of the IPPM service 222 in a network such as the Internet 224 to which the wireless router device can connect.

The managed device can also be connected to an upstream network 224, can acquire an IP address automatically and can repeatedly attempt to connect to the IPPM service 222 over the network 224 using a secure communications method such as HTTPS as shown in step 203.

Once a connection is made the managed device can use a security key to authenticate with the IPPM service 222 in step 204a. If unsuccessful in step 204b, then a default DHCP configuration can be applied in step 204c before looping back to step 203. If successful in step 204b, in step 205 the managed device can receive a set of configuration data, including, but not limited to, DHCP configuration from the IPPM service 222. The managed device can also receive updated security keys, specific to the particular device, for use in future communications. The managed device can update the new configuration to the locally connected services and cause the services to re-initialize or otherwise apply the new configuration and commence operation in step 206.

Thereafter, when DHCP events are detected in step 207, in step 208 the managed device can send alerts and notification information to the IPPM service 222 via network 224 and also periodically send status information to the IPPM service 222 via network 224. In the example embodiment, the DHCP service can generate an event notification every time a DHCP lease is granted or renewed. The IPPM service 222 can also send configuration updates to the managed device when necessary via network 224, and if a configuration change is detected in step 209a, it may be applied in step 209b for updating the locally connected services, such as a DHCP server.

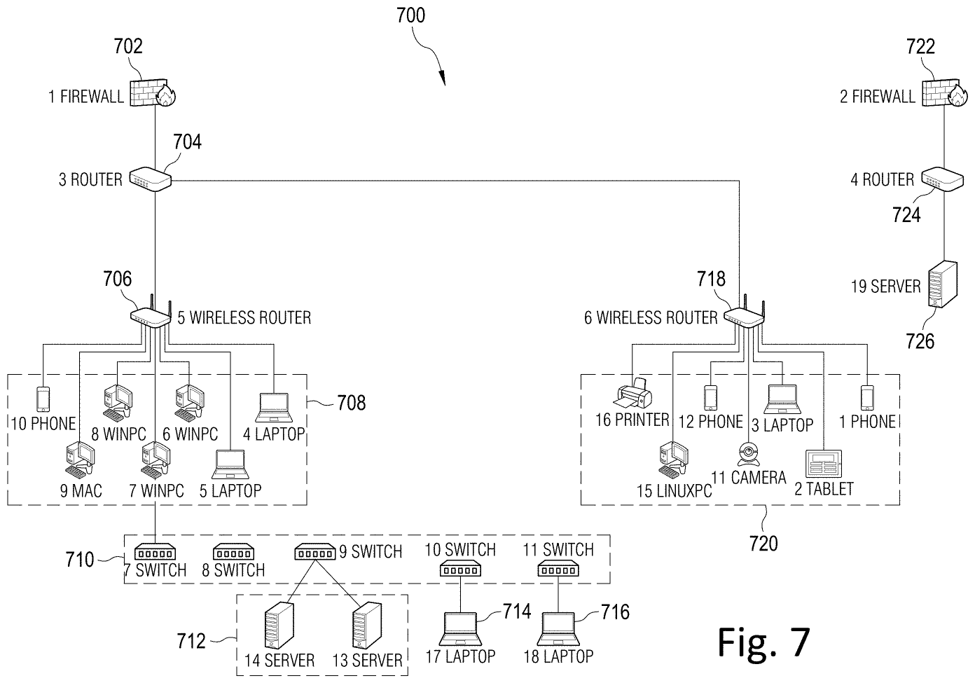

Discovery and status information received from a plurality of devices on the network can allow the IPPM to automatically generate a graphical user interface representation of the network on a computer screen, as illustrated in the example embodiment diagram of FIG. 7. In some embodiments, details of an individual device can be obtained by clicking or otherwise selecting a corresponding device icon using a computer mouse or other user interface to bring up a user interface screen for displaying or editing the device attributes. In the network shown in the example embodiment, Firewall 702 is coupled with router 704 which is coupled with wireless routers 706 and 718. Wireless router 718 is connected to devices 720 such as a printer, linuxpc, laptop, camera, laptop, tablet and smartphone. Wireless router 706 is connected to devices 708 which can be similar to those listed above and is also coupled with switches 710. Two servers 712 can be connected to one switch, while other switches connect individually to laptops 714 and 716. Firewall 722 can be coupled with router 724, which can be coupled with server 726.

### Setting and Applying Policy

Also included is a method of developing a policy that effects the desired characteristics of the network, as provided by an administrator, in a way that can be applied to each of the network infrastructure devices as described below;

Each network policy can be expressed as a set of high level rules that can be compiled into configuration instructions for a plurality of services and deployed to each of the managed network devices respectively. Policies can be entered in the IPPM service in a number of ways, including from text based files and graphical user interfaces.

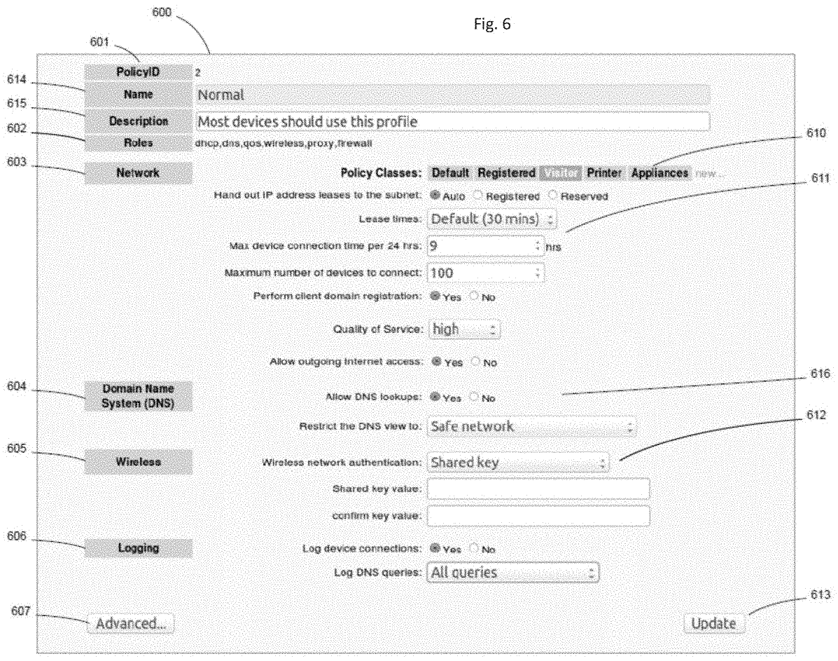

FIG. 6 demonstrates an example embodiment of a graphical user interface page 600 for inputting policy rule expressions. As shown in the example embodiment, a user or administrator can select or create a PolicyID 601 with a Name 614 and Description 615. A list of roles that the policy applies to can be shown in Roles field 602.

A Network area 603 can include information such as Policy Classes 610 that are selectable, for instance Default, Registered, Visitor, Printer, Appliances, New and others. The user can then set particular features 611 using radio buttons, drop down menus and other interactive buttons. These can include whether to hand out IP addresses to leases on the subnet as auto, registered or reserved radio buttons; lease times; maximum device connection time per 24 hours; maximum number of devices to connect; whether to perform client domain registration or not; quality of service and whether to allow outgoing Internet access or not.

A Domain Name System (DNS) area 604 can include radio buttons about whether to allow DNS lookups and a menu to select whether to restrict the DNS view for a safe network or other network.

A Wireless area 605 can include features 612 such as a drop down menu for wireless network authentication such as a shared key and input areas for shared key value and key value confirmation.

A Logging area 606 can include radio buttons to log device connections or not and a drop down menu about which DNS queries should be logged. Users can also select to enter an advanced settings button 607 or an update button 613.

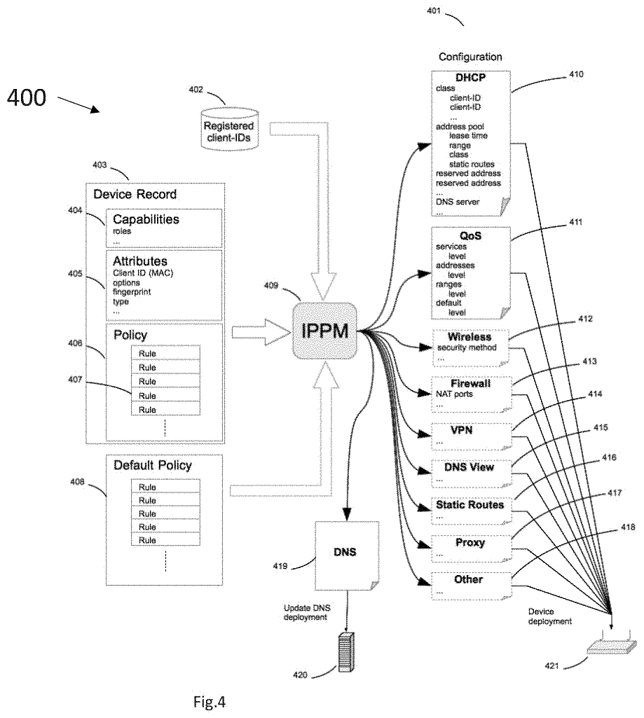

FIG. 4 illustrates an example embodiment flow 400 of data for a managed device 421 discovered as part of the network whereby a device record 403 includes: a.) known capabilities 404 of managed device 421, including service roles supported by the managed device 421; b.) attributes 405 of managed device 421 reported by the managed device 421 and other devices to which managed device 421 can be connected, including, but not limited to; Client ID (MAC address), (DHCP) fingerprint, (vendor) options, type and others; and c.) a policy 406 previously created and assigned to the managed device 421, either explicitly (manually) or implicitly (automatically), containing one or more rules 407 that can be applied for the service roles supported by the managed device 421.

A system default policy 408 can also be created including one or more rules in order to account for cases where the assigned policy 406 does not include a rule for a service role in capabilities 404.

By way of example, network policies and rules can include management of individual device behavior and can include: Default Policy Rules, Guest Policy Rules, Normal Policy Rules, Default Classes, and Policy Classes including one or more of Registered, Visitor, Printer, Appliance and Printer. Each of these will be described in turn as follows:

Default Policy Rules can include: a.) Up to 128 hosts may be connected to each managed network device, b.) Hosts shall not be connected wirelessly, c.) Hosts shall receive short term leases, d.) Unknown user hosts may not connect to any company-internal services or workstations, e.) Hosts shall have no Internet access, except to IPPM service, f.) Hosts shall have low level quality of service (QoS), and g.) Host connections (i.e. address leases) shall be logged to a central monitor.

Guest Policy Rules can include: a.) Up to 100 hosts may be connected, b.) Applies to all or specified host types, c.) Hosts shall receive short term leases only, d.) Hosts may not connect to any company-internal services or workstations, e.) Hosts may connect to the Internet at a low level QoS, f) Host connections (i.e. address leases) shall be logged to a central repository, and g.) Hosts shall receive a restricted DNS view when making DNS requests.

Normal Policy Rules can include the following: a.) Up to 1000 (wired) hosts may be connected, b.) Up to 100 (wireless) hosts may be connected, c.) Wireless hosts shall authenticate using name and password, and d.) Host connections (i.e. address leases) shall be logged to a central repository.

A Default class can include the following: a.) Hosts shall receive short term leases only, b.) Hosts may not connect to any services, c.) Hosts shall have no Internet access, except to IPPM service, and d.) Hosts may receive low level QoS.

A Registered Policy class can include the following: a.) No default devices and b.) Hosts may be wired or wireless, where these hosts may be subject to the following: 1.) Hosts shall be previously registered, 2.) Hosts may connect to the Internet, 3.) Hosts may connect to the VPN, 4.) Hosts shall make use of a safe DNS profile, 5.) Hosts may access company-internal services, 6.) Hosts may receive high QoS, 7.) Hosts may receive medium term leases, 8.) Hosts may be automatically registered with the DNS server, 9.) Network routes to company-internal services may be set up automatically, 10.) VPN connection to company-internal services may be set up automatically, and 11.) Network routes to printers may be set up automatically.

A Visitor Policy class can apply to tablets, smartphones, laptops, wearable devices, game consoles and other portable devices and includes: a.) Hosts shall receive short term leases only, b.) Hosts may not connect to any company-internal services or workstations, c.) Hosts may connect to the Internet, and d.) Hosts may receive low level QoS.

A Printer Policy class can apply to printers, scanners and information display devices and can include the following: a.) Printers shall receive long term leases, b.) Printers may not connect to the Internet, c.) Printers may receive mid-level QoS, and d.) Printers may be automatically registered with the DNS server.

Turning to FIG. 9, an Appliance Policy class can apply to IP cameras 902, thermostats 901, alarms sensors 903, VoIP devices 904, smart kitchen 905 or other home or office appliances, physical access devices such as door locks and the like: a.) Appliances shall receive long term leases, b.) Appliances may not connect to the Internet, c.) Appliances may receive high level QoS, and d.) Appliances may be automatically registered with the DNS server.

Servers Policy Rules can include a Default class and a Server Policy class that applies only to servers, pc and mac types. A Default class can include the following: a.) Hosts shall receive short term leases only, b.) Hosts may not connect to any services, c.) Hosts shall have no Internet access, except to IPPM service, and d.) Hosts may receive low level QoS. A Server Policy class can include the following: a.) Hosts shall receive reserved IP addresses, b.) Hosts shall have wired connections, c.) Hosts shall make use of a limited DNS profile, d.) Hosts may be automatically registered with the DNS server, and e.) Hosts may receive mid-level QoS.

The preceding list should be understood to be an example embodiment only and numerous other categories and classes of policies may be used, as appropriate. Some examples include policies for customers, students, contractors, affiliates, executives, and others.

IPPM process 409 can accept as input the device record 403, the default policy 408, real-time information from a database of registered client devices 402 and others and can apply the rules contained in the policy 406 and the default policy 408. The application of the rules can be translated into a set of configuration instructions 401 particular to managed device 421. Included in the set of configuration instructions 401 and can be configuration instructions for at least one service role including DHCP 410, such as class with client-IDs, address pools with lease times, ranges classes and static routes, reserved addresses and DNS Servers; QoS 411 including services by levels, addresses by levels, ranges by levels and defaults by levels; Wireless 412 including security methods; Firewall 413 including NAT ports; VPN 414; DNS 415; static routes 416; Proxy 417 and others 418. IPPM process 409 can also update the configuration of network services, for example DNS service 419 hosted on server 420, that can be remotely located from device deployment 421, in order to register new host addresses.

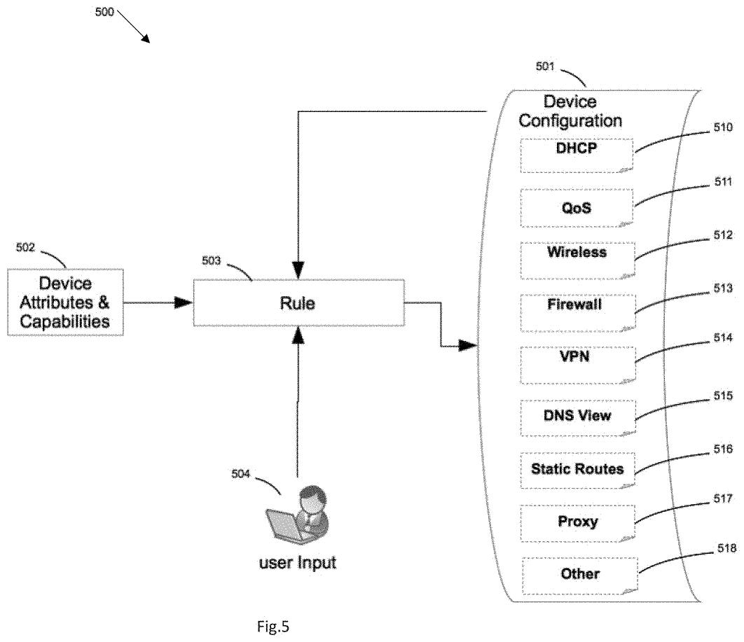

FIG. 5 shows an example embodiment of an IPPM application diagram 500 of a single rule 503 from a plurality of rules in a policy, whereby a discovered, managed device's attributes and capabilities 502 are combined with parameters previously or concurrently entered as user input 504 by a user such as a network administrator in order to generate a current state of the device configuration 501. A result (output) of applying the rule 503 can result in an update to the device configuration 501 in one or more service roles under configuration control. This can include at least DHCP 510, QoS 511, wireless (router) 512, firewall 513, VPN 514, DNS View 515, static routes 516, proxy 517 and others 518.

Inputs of the rule can be derived from: a.) device attributes and capabilities 502 for the managed device to which the rule 503 is applied, such as the state and attributes of the managed device including: client ID (e.g. mac address), vendor class, DHCP options fingerprint, and others; b.) rule parameters such as a number of hosts to be served, lease times, and others, as entered by the user as user input 504; c) a device configuration 501 generated by other rules in the policy, such as the IP address range of the DHCP pool. DHCP configuration can set up a number of address pools and client classes, to which various clients identified by host device type and ID are assigned. In turn these pool addresses can be used in different rules for setting QoS levels and firewall permissions, while d.) predetermined parameters can be assigned as conditions of rules, for example: some reserved hosts with fixed IP addresses can be set up in a rule, as these are not expected to change.

Elaborating on FIG. 6, with its relation to FIG. 5 user input 504, an example embodiment of how a user, such as a network administrator, may configure a policy using a graphical user interface of a user input policy definition page 600. Service roles 602 can be defined when the policy is created and can limit which service parameters are available for user configuration. Within a policy the user can define policy classes. For example, in a network policy 603 there can be a class 610 defined for each functional set of the managed device, such as, if a managed device is configured to handle a ‘Visitor’ class, its policy can be configured to enable various functions that allow previously unknown hosts (“Visitor” devices) to connect to the network. Each class can present different parameters 611 for administrator configuration.

FIG. 6 also illustrates an example embodiment of how a policy can include configuration of network devices for distributed services separate from the devices, such as DNS service 604 and logging service 606.

FIG. 6 also illustrates an example embodiment of how system-wide parameters can be deployed to managed network devices, such as deployment of a shared key 612 for wireless device access 605. An alternative Radius server configuration, which can be used for per-host authentication for registered devices, is not shown since the ‘Shared Key’ authentication method was previously selected in the example embodiment.

### Device Configuration

DHCP configuration can include one or more lease pools, lease reservations based on client identifiers, lease classes to which clients may be assigned and lease options. Relevant DHCP Options, which are defined by Dynamic Host Configuration protocol, R. Droms, Mar 1997, IETF and [RFC3442 (https://tools.ietf org/html/rfc3442)] include: Routers (option 3), DNS servers (option 6), Host Name (option 12), NTP servers (option 44), Vendor-specific (option 43), SMTP servers (option 69), Lease Time (option 51), Server Identifier (option 54), Vendor class identifier (option 60), Client identifier (option 61), and Classless Static Route (option 121) [RFC3442 (https://tools.ietf.org/html/rfc3442)].

Each DHCP server can exhibit different feature capabilities, resulting in differing configuration formats. For example, the ISC DHCP configuration for reserved host MAC addresses is described in DHCP server documentation, Internet Systems Consortium, 2001-2015, which is different from the configuration for DHCP reserved host MAC addresses in DnsMasq Man Page, Simon Kelley, Sep 2014 (accessible at http://www.thekelleys.org.uk/dnsmasq/docs/dnsmasq-man.html) and each could be applied on different target devices. Therefore, the IPPM policy rules can be applied in accordance with the known capabilities of each target device, so that target devices are not assigned configurations for capabilities they do not possess.

Wireless 802.11 (Wi-Fi) router configuration can be set up as a subnet of a wired network. In an example embodiment, a wireless router can host a DHCP server that can be configured independently from the parent network's DHCP server. In another example embodiment, a wireless router configuration can include settings for wireless access point and wireless security to allow the wireless network to be remotely managed. For example, security settings can include: a.) WPA2-PEAP using Radius to authenticate users individually, whereby a Radius service is separately located from the router, for example in the Internet ‘cloud’ and b.) WPA shared secret to authenticate users using the same secret that is part of the wireless router configuration.

Quality of Service (QoS) configuration can be based on a client IP address range that is set by a DHCP server. In an example embodiment, a minimum level of service can be determined on a per IP address, and therefore per client, basis. In another example embodiment, a QoS configuration can include other router settings to enable QoS to be varied according to: a.) Service port ranges, generally related to a network protocol in use, can be used to determine QoS (For example Voice-over-IP protocol can be assigned a high level of service (low latency) and file downloads can be assigned a low level of service (high latency)), b.) Protocol types, such as UDP or TCP, can be assigned different levels of service, and c.) Protocol L7 analysis, to determine network services in use, can be used to determine QoS. For example, services such as specific HTTP downloads can be assigned a special level of service.

VPN Tunnels can be configured as servers and clients, whereby security keys can be generated and installed, and network routes can be set up in accordance with policy rules.

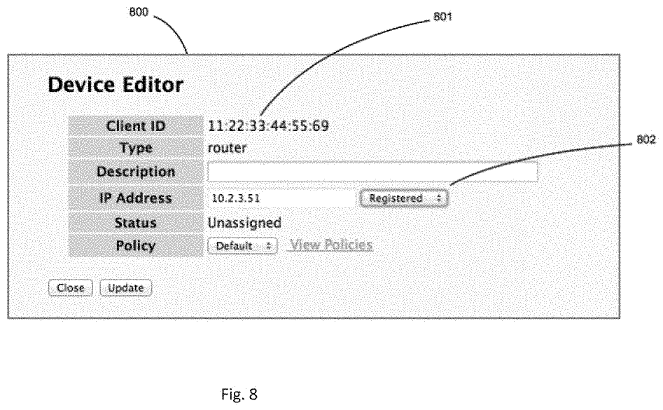

User host DNS registration can be used as an input to the IPPM policies, whereby a client ID, such as a Media Access Control (MAC) address of a host computer, can be used to associate a device with a known user. Host registration can be manually configured from an administrator console. For example, turning to FIG. 8, an embodiment of a Device Configuration Editor Screen 800 is shown whereby a user can proceed in setting a Registered option 802 for a Client ID 801. In an example embodiment of the invention, IPPM can receive information from the registration server as is described in Data/Network Services, How is Virginia Tech using DHCP? Virginia Polytechnic Institute and State University, November 2000, How our ‘plug in and go’ laptop network DHCP portal works, Chris Siebenmann, University of Toronto, September 2009, and BYOD Begins with Device Registration, Bluecat Networks Inc., June 2012 by a message received or by requesting said information from a database or directory associated with a registration server. Registered host information can be updated in the network configuration and deployed to all the related network infrastructure devices.

### Configuration Deployment

Configuration deployment starts when IPPM receives a message sent from a network infrastructure device, such as a status update, alert message or an event notification and the IPPM has an updated configuration waiting. The IPPM can then respond by sending a configuration update to the device. Depending on the capabilities of the device, the configuration update can be in the form of one or more configuration files or a set of commands needed to update the device configuration of each service role.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed. Additionally, all publications discussed herein are hereby incorporated by reference in their entirety.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method for configuring a network with an IP policy management service and a plurality of distributed managed network devices supporting one or more service roles, wherein the IP policy management service performs steps comprising:
discovering the at least one managed network devices;
determining the configuration of each managed network device based on selection of a policy for the discovered managed network device, wherein the policy includes at least one rule specific to each of the service roles and one or more capabilities of the discovered managed network device; and
configuring each of the discovered managed network devices by deploying one or more configuration updates via the network to the discovered managed network devices.

2. The method of claim 1, wherein the supporting service roles include at least one of: a DHCP service, a VPN tunnel, Quality of Service (QoS), a router, a wireless router, a network firewall, a DNS service, and a network proxy.

3. The method of claim 1, wherein the discovered managed network device is configurable to use Internet-based cloud services.

4. The method of claim 1, wherein the at least one rule specifies one setting of the discovered managed device behavior.

5. The method of claim 1, wherein alerts and status information are forwarded to the IP policy management service by the discovered managed network device based on internal network device event notifications or periodically.

6. The method of claim 5, wherein a representation of the network, determined from discovery results and DHCP and other event notifications for the discovered managed devices, is visually represented on a user display screen in a graphical user interface to a user.

7. The method of claim 6, wherein the visual representation of the discovered managed device can be manipulated on-screen by the user interacting with the graphical user interface using a user input to configure the policy for the discovered managed device.

8. A system for configuring a network with an IP policy management service and a plurality of distributed managed network devices supporting service roles, comprising:
the IP policy management service communicatively coupled to the network, wherein at least one distributed managed network device is discoverable;
the IP policy management service operable once a managed network device is discovered to perform:
a configuration for the discovered managed network device as determined by a selection of a policy in the IP policy management service, wherein the policy includes at least one rule stored in non-transitory memory and is specific to at least one service role and capability of the discovered managed network device; and
a configuration deployment for the discovered managed network device via the network to the discovered managed network device.

9. The system of claim 8, wherein the supporting service roles include at least one of: a DHCP service, a VPN tunnel, Quality of Service (QoS), a router, a wireless router, a network firewall, a DNS service, a network proxy.

10. The system of claim 8, further comprising:
internet-based cloud services communicatively coupled to the network and operable to be accessed and used by the discovered managed network device.

11. The system of claim 8, wherein the rule specifies a setting of the discovered managed device behavior.

12. A method of developing a policy for at least one distributed network device communicatively coupled to a network with an IP policy management service and a plurality of distributed managed network devices supporting service roles, wherein the IP policy management service performs the method having steps comprising:
using a management device having at least one processor and non-transitory memory with instructions stored therein, executing the instructions using the processor to:
automatically discover capabilities of at least one managed network device on the network;
automatically determine current attributes of the discovered network device;
implement rules from a set of rules appropriate for the managed device stored in non-transitory memory as selected by an administrator using a user input;
store rule parameters entered by an administrator;
read prior device configurations from management service non-transitory memory;
review and compile the policy; and
save the policy to management service non-transitory memory.
